(19) United States
(12) Patent Application Publication
(10) Pub. No.: US 2005/0270913 A1
(43) Pub. Date: Dec. 8, 2005

(54) Method and apparatus for detecting the landing of optical pickup head

(75) Inventor: Ming-Chuan Chiang, Taipei (TW)

Correspondence Address: BRUCE H. TROXELL, SUITE 1404, 5205 LEESBURG PIKE, FALLS CHURCH, VA, 22041, US

(73) Assignee: ALi Corporation

(21) Appl. No.: 10/986,013

(22) Filed: Nov. 12, 2004

(30) Foreign Application Priority Data
Jun. 8, 2004 (TW) 93116365

(51) Int. Cl. G11B 7/00

(52) U.S. Cl. 369/44.14; 369/44.11

(57) ABSTRACT

The present invention discloses a method for detecting the landing of an optical pickup head in an optical disk drive, characterized in that the electric current of a sled motor of the optical pickup head is detected to determine whether or not the optical pickup head is parked on a landing zone. The invention can effectively detect whether or not the optical pickup head is parked as to save costs and improve product quality.

### 1. FIELD OF THE INVENTION

The present invention relates to a method and apparatus for detecting the landing of an optical pickup head, and more particularly, to a method and an apparatus for detecting the landing of an optical pickup head by sensing the variation of electric current in an optical disk drive.

### 2. BACKGROUND OF THE INVENTION

At present, since the research and development of optical disk drive has already reached a mature stage, which is the cause of price drop problem faced by the current market of optical disk drive, cost-down inevitability becomes the primary means of maintaining competitiveness for most optical disk drive manufacturers. Under the cost-down policy, many optical disk drives are manufactured by some less precise technologies or constructions, which usually has poor quality.

As to the technology of detecting the landing of an optical pickup head in an optical disk drive, the consequences of the cost-down policy are that, while landing an optical pickup head, it is easy to misjudge whether an optical pickup head is parked on a landing zone, or the optical disk drive will have a prolonging seek time, the optical disk drive will consume more electricity than normal. Hence, it is necessary to balance the requirements of cost-down and quality while providing a method for detecting the landing of an optical pickup head.

Therefore, the present invention provides a method for detecting the park of an optical pickup head of an optical disk drive while saving cost and improving product quality.

Under the consideration of cost-down, there are two conventional methods for detecting the landing of an optical pickup head in an optical disk drive. The first method uses a low-cost limit switch to detect whether the optical pickup head had parked on the landing zone, and the other method uses a timing software for the detection.

Please refer to FIG. 1 for a schematic diagram depicting a conventional method of detecting whether an optical pickup head had parked on a landing zone by a limit switch. In FIG. 1, the limit switch 110 is installed at the position of a landing zone for an optical pickup head driven by a sled motor 120 to park. Therefore, when the sled motor 120 carries an optical head 130 to the landing zone, the optical pickup head 130 will come into contact with the limit switch 110 that indicates the optical pickup head 130 had parked on the landing zone. However, the conventional low-cost limit switch 110 may be damaged easily and will not be able to determine whether or not the optical pickup head is parked.

Another conventional method for detecting the landing of an optical pickup head without using the limit switch 110 is by using a software program to count the time for determining whether or not an optical pickup head is parked on the landing zone. For example, as soon as the sled motor 120 carries the optical pickup head 130 to move, the software program inside the optical disk drive begins to count the time, namely 5 seconds. After the program counts for 5 seconds, the optical pickup head 130 is considered as parked. However, the time for the sled motor 120 to move the optical pickup head 130 to the landing zone is not necessarily 5 seconds but depends on the position of the pickup head 130. The farther the optical pickup head 130 from the landing zone, the more time it takes to park the optical pickup head 130; and vice versa. Therefore, if the optical pickup head 130 is at the position close to the park position which had reach the landing zone less than 5 second, the sled motor 120 will continue running when the optical pickup head 130 had already parked on the landing zone for the software program to finish counting the time of 5 seconds. As a result, the method of detecting the landing of an optical pickup head by a timing software often causes the sled motor 120 to continue operate even after the optical pickup head 130 has already parked on the landing zone and thus causes unnecessary power consumption and expenses. Further, it will be inappropriate that if the method of using a timing software for detecting the landing of an optical pickup head is applied on handheld devices that have much concern about the power consumption, such as a palm optical disk player.

In summation of the description above, the present invention provides a method and an apparatus for effectively detecting the landing of an optical pickup head in an optical disk drive while balancing the requirements of cost saving and product quality enhancing.

### SUMMARY OF THE INVENTION

The primary objective of the invention is to provide a method for detecting the landing of an optical pickup head in an optical disk drive, characterized in that: determining whether or not the optical pickup head is parked on a landing zone by detecting an electric current of a sled motor carrying the optical pickup head.

According to a preferred embodiment of the present invention, the method further comprises: detecting the waveform of the electric current for determining whether or not the optical head is parked, wherein a height limit is provided for the determination, such that if the waveform of the electric current is higher than the height limit, the optical pickup head is determined as parked; or a height limit and a time limit are provided, such that if the waveform of the electric current is higher than the height limit and the delay exceeds the time limit, the optical pickup head is determined as parked.

In another preferred embodiment of the present invention, the method further comprises: detecting a voltage difference of the electric current at a load thereof for determining whether or not the optical pickup head is parked on a landing zone, wherein a numeric limit is provided, such that if the voltage difference is larger than the numeric limit, the optical pickup head is determined as parked; or a numeric limit and a time limit are provided, such that if the voltage difference is larger than the numeric limit and the delay exceeds the time limit, the optical pickup head is determined as parked.

Another objective of the present invention is to provide an apparatus for detecting the landing of an optical pickup head in an optical disk drive, which comprises an ammeter and a control unit, wherein the ammeter is installed on an output path of a sled motor that carries the optical pickup head for detecting an output current of the sled motor and outputting a result signal, and the control unit receives the result signal to determine whether or not the optical pickup head is parked.

In a preferred embodiment of the present invention, the control unit further comprises an analog/digital converter and a digital signal processing device, wherein the analog/digital converter receives the result signal to output a digital signal. The digital signal processing device receives the digital signal to determine whether or not the optical pickup head is parked.

A further objective of the present invention is to provide another apparatus for detecting the landing of an optical pickup head in an optical disk drive, which comprises a voltmeter and a control unit, wherein the voltmeter is also installed on an output path of a sled motor that carries an optical pickup head of an optical disk drive for detecting an output voltage of the sled motor to output a result signal, and the control unit receives the result signal to determine whether or not the optical pickup head is parked.

In a preferred embodiment of the present invention, the control unit further comprises a load and a differential amplifier; wherein the load is installed onto the output path, and the differential amplifier receives signals from both terminals of the load to output a result signal.

In summation of the description above, the present invention provides a method and an apparatus for detecting the landing of an optical pickup head in an optical disk drive by detecting the electric current of a sled motor that carries an optical pickup head to determine whether or not the optical pickup head is parked on a landing zone.

### BRIEF DESCRIPTION OF THE DRAWINGS

FIG. 1 is a schematic diagram depicting a conventional method of detecting whether an optical pickup head had parked on a landing zone by a limit switch.

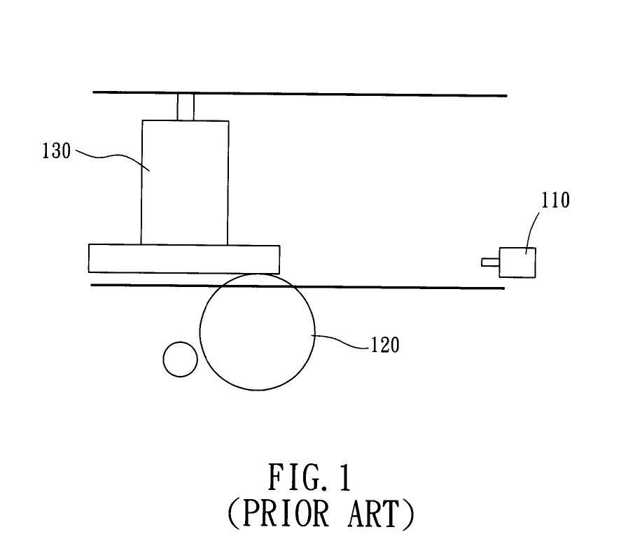

FIG. 2 is an ampere-time chart of a running sled motor carrying an optical disk drive.

FIG. 3 is a schematic circuitry of an apparatus for detecting the landing of an optical pickup head in an optical disk drive according to a preferred embodiment of the present invention.

FIG. 4 is a flow chart depicting the method for detecting whether or not an optical pickup head is parked on a landing zone according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

If a low-cost limit switch is used to determine whether or not an optical pickup head is parked according to a prior art, such low-cost limit switch may be easily damaged, which will cause the optical disk drive unable to determine whether or not the optical pickup head is parked on the landing zone, and if the landing of an optical pickup head is determined by a timing software program, it will take much time during the process of parking the optical pickup head and consume too much electric power. Therefore, the present invention intends to use the electric current of the sled motor carrying n optical pickup head to determine whether the optical pickup head is parked on a landing zone.

When the sled motor carrying the optical pickup head is running, electric currents of different magnitudes are outputted due to the external resistance (such as static friction and dynamic friction, etc) exerted thereon in order to maintain the continuous movement of the sled motor.

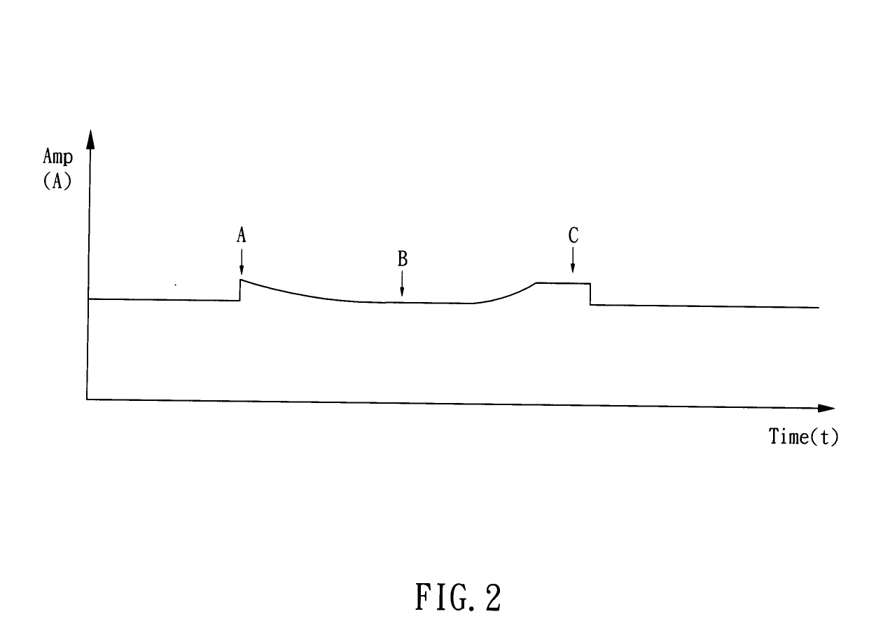

Please refer to FIG. 2 for the ampere-time chart of a running sled motor carrying an optical disk drive. In FIG. 2, A refers to the electric current outputted by a sled motor which overcomes the static friction occurs when the sled motor is about to start running; B refers to the electric current outputted by the sled motor which overcomes the dynamic friction occurs when the sled motor is moving; and C refers to the electric current outputted by the sled motor which overcomes the incapability of its continuous movement due to external forces when the sled motor moves to a specific position that it cannot move any further (in other words, the sled motor carrying the optical pickup head has moved to the landing zone).

As seen in FIG. 2, during the process of moving the optical pickup head to the landing zone, the waveforms of the electric currents outputted by the sled motor are are different at each stage, where the sled motor carrying the optical pickup head is parked, starts running, and is running. Moreover, after the sled motor carrying the optical pickup head is parked, the waveform of the outputted electric current has higher potential and lasts for longer period of time.

Therefore, the present invention intends to determine the landing of an optical pickup head by detecting the electric current passing through the sled motor carrying the optical pickup head.

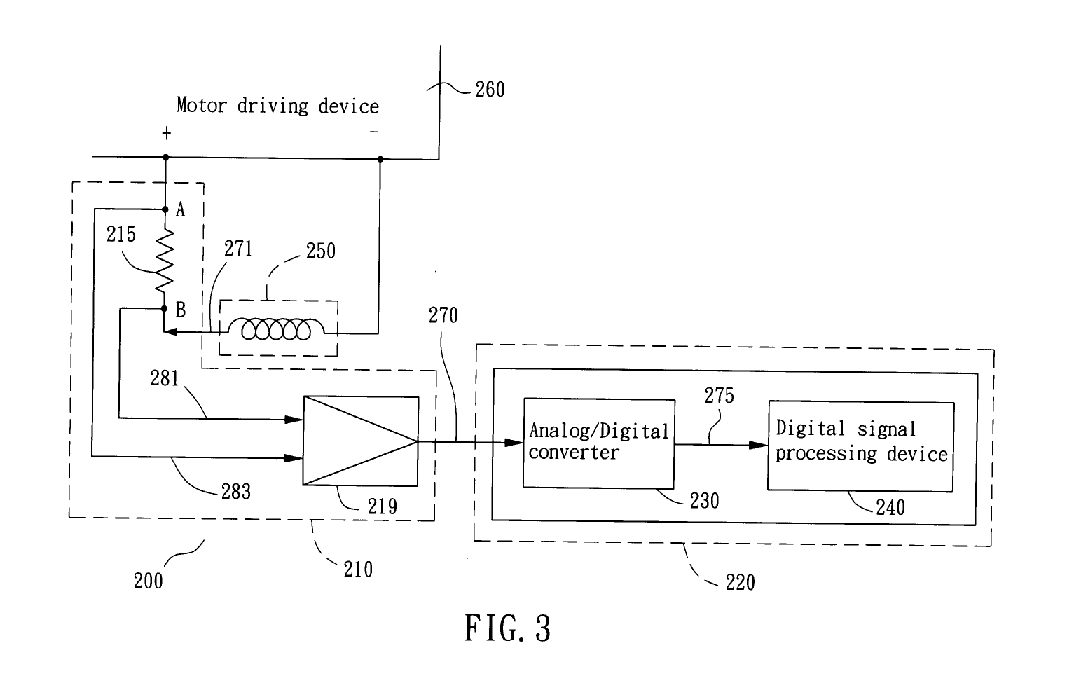

Operationally, an ammeter or a voltmeter can be used to detect the waveform of the electric current passing through the sled motor. Please refer to FIG. 3 for a schematic circuitry of an apparatus for detecting the landing of an optical pickup head in an optical disk drive according to a preferred embodiment of the present invention. In FIG. 3, the apparatus 200 comprises a voltmeter 210 and a control unit 220; wherein the voltmeter 210 is installed at the electric current output path from the sled motor 250 to a motor driving device 260.

In this preferred embodiment of the present invention, the voltmeter 210 uses a resistor 215 as a load and connects the same in series with the electric current output path from the sled motor 250 to the motor driving device 260, so that when the electric current 217 outputted by the sled motor 250 passes through the resistor 215, a voltage difference can be detected at both terminals A and B of the resistor 215. The voltmeter 210 further uses a differential amplifier 219 to receive output signals 283, 281 of the resistors 215 at terminals A and B respectively and output a result signal 270 when the voltage difference of at the terminals A and B of the resistor 215 is produced. Therefore, when the sled motor 250 outputs electric current 217, the result signal 270 is outputted through the resistor 215 and the differential amplifier 219 such that a voltage drop of the electric current passing through the resistor 215 can be obtained.

According to the equation of the Ohm's Law, Voltage (V)=Current (I)×Resistance (R). With a constant resistance of the resistor 215, the magnitude of electric current 217 can be measured with respect to the voltage drop of the electric current 217 passing through the resistor 215. By the result signal 270, it is known to the control unit 220 that the change of the ampere-time waveform of the electric current 217 is similar to the waveform change seen in FIG. 2.

As to the control unit 220, this preferred embodiment adopts a digital processing method to determine and output the result of the detection of the landing of an optical pickup head (not shown in the figure). In this regard, the control unit 220 comprises an analog/digital converter 230 and a digital signal processing device 240, wherein the analog/digital converter 230 receives the result signal 270 from the ammeter 210 and outputs a digital signal 275 to the digital signal processing device 240. The control unit 220 detects the variation of the ampere-time waveform of the electric current 217 outputted by the sled motor 250 by detecting the result signal 270 outputted by the ammeter 210.

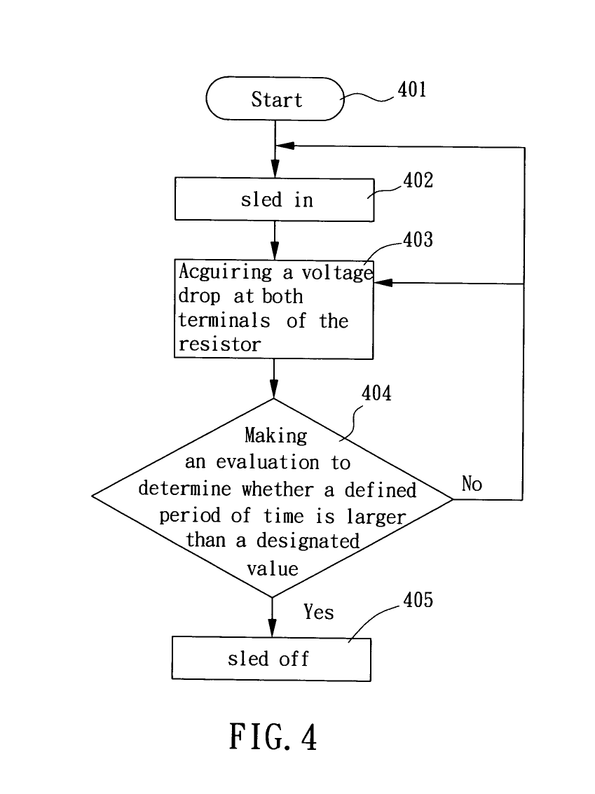

Please refer to FIG. 4 for a flow chart depicting the method for detecting whether or not an optical pickup head is parked on a landing zone according to the present invention. The process starts at step 401 and proceeds to step 402. In the step 402, the optical pickup head starts to move and the flow proceeds to step 403. In step 403, when the optical pickup head starts running, a detect device 200 is used to acquire the variation of the ampere-time waveform of the electric current 217 outputted by the sled motor 250 by using a voltmeter (or an ammeter) to detect a voltage drop at both terminals A and B of the resistor 215, and then the flow proceeds to step 404. In the step 404, the control unit 220 will make an evaluation to determine whether the voltage drop detected at both terminals A and B of the resistor 215 is larger than a numeric limit and, if it is larger than the numeric limit, the control unit 220 is required to make another evaluation to determine whether the delay exceeds a time limit, both according to the result signal 270 detected by the ammeter 210. If both conditions are met, which represents that the waveform is similar to that as shown in FIG. 2, and the control unit 220 will determine the optical pickup head as parked and the flow proceeds to step 405; otherwise, the optical pickup head will be determined as not parked and the flow proceeds to step 403.

In step 405 that the optical pickup head is determined to be parked on the landing zone, the control unit 220 will output a signal to control and stop the sled motor 250. Further, if the optical pickup head has not been parked, the detect device 200 will continue the flow from step 403 of measuring the voltage drop between both terminals A and B of the resistor 215 by the voltmeter 210.

By detecting the electric current passing through the sled motor carrying the optical pickup head, whether or not the optical pickup head is parked on a landing zone can be determined and the sled motor can be stopped immediately so as to effectively save the unnecessary power consumption. Compared with the low-cost limit switch, the actual cost for the voltmeter (or ammeter) and the control unit is even lower than the limit switch.

In summation of the description above, the present invention provides a method and an apparatus for detecting the landing of an optical pickup head in an optical disk drive by detecting the electric current passing through the sled motor carrying the optical pickup head. Besides the effective determination, the invention also maintains a low-cost expenditure. Therefore, the invention can achieve the purpose of effectively detecting the landing of an optical pickup head while balancing the considerations of cost and product quality.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A method for detecting the landing of an optical pickup head in an optical disk drive, comprising the step of:
determining whether or not the optical pickup head is parked on a landing zone by detecting an electric current of a sled motor carrying the optical pickup head.

2. The method as recited in claim 1, the method further comprising the step of:
detecting the waveform of the electric current for determining whether or not the optical head is parked on the landing zone.

3. The method as recited in claim 2, the method further comprising the step of:
providing a height limit, wherein the optical pickup head is determined as parked while the waveform of the electric current is higher than the height limit.

4. The method as recited in claim 2, the method further comprising the step of:
providing a height limit and a time limit, wherein the optical pickup head is determined as parked while the waveform of the electric current is higher than the height limit and a delay exceeds the time limit.

5. The method as recited in claim 1, the method further comprising the step of:
detecting a voltage difference of the electric current at a load for determining whether or not the optical pickup head is parked on a landing zone.

6. The method as recited in claim 5, the method further comprising the step of:
providing a numeric limit, wherein the optical pickup head is determined as parked while the voltage difference is higher than the numeric limit.

7. The method as recited in claim 5, the method further comprising the step of:
providing a numeric limit and a time limit, wherein the optical pickup head is determined as parked while the voltage difference is higher than the numeric limit and the delay exceeds the time limit.

8. An apparatus for detecting the landing of an optical pickup head in an optical disk drive, comprising:
an ammeter, installed onto an output path of a sled motor carrying the optical pickup head for detecting an output current of the sled motor and outputting a result signal; and
a control unit, for receiving the result signal to determine whether the optical pickup head is parked on a landing zone.

9. The apparatus as recited in claim 8, wherein the control unit comprises:
an analog/digital converter, for receiving the result signal to output a digital signal; and
a digital signal processing device, for receiving the digital signal to determine whether the optical pickup head is parked on the landing zone.

10. An apparatus for detecting the landing of an optical pickup head in an optical disk drive, comprising:
a voltmeter, installed onto an output path of a sled motor carrying the optical pickup head for detecting an output voltage of the sled motor and outputting a result signal; and
a control unit, for receiving the result signal to determine whether the optical pickup head is parked on a landing zone.

11. The apparatus as recited in claim 10, wherein the voltmeter comprises:
a load, installed on the output path; and
a differential amplifier, for receiving signals from both terminals of the load to output the result signal.

12. The apparatus as recited in claim 10, wherein the control unit comprises:
an analog/digital converter, for receiving the result signal to output a digital signal; and
a digital signal processing device, for receiving the digital signal to determine whether the optical pickup head is parked on the landing zone.
